(19) United States
(12) Patent Application Publication
(10) Pub. No.: US 2026/0316565 A1
(43) Pub. Date: Oct. 15, 2026

(54) Motor Vehicle Having a Display Unit

(71) Applicant: Bayerische Motoren Werke Aktiengesellschaft, Muenchen (DE)

(72) Inventors: Harald LATHWESEN, Mauern (DE); Sonja Ruemelin, Muenchen (DE); Peter SCHNEIDER, Haar (DE); Michael WOKRINEK, Bruckberg (DE)

(21) Appl. No.: 19/117,121

(22) PCT Filed: Oct. 13, 2023
(86) PCT No.: PCT/EP2023/078439

§ 371 Date: Mar. 31, 2025

(30) Foreign Application Priority Data
Oct. 13, 2022 (DE) 10 2022 126 801.2

(51) Int. Cl. B60K 35/231; B60K 35/233; B60K 35/235; B60K 35/53; B60K 35/60; G02B 27/00; G02B 27/01

(52) U.S. Cl. CPC B60K 35/231; B60K 35/233; B60K 35/235; B60K 35/53; B60K 35/60; G02B 27/0093; G02B 27/0101; B60K 2360/771; G02B 2027/013

(57) ABSTRACT

A motor vehicle has a display unit, which is arranged on an inside of a vehicle roof. The display unit has a permanently integrated imaging device, which in particular cannot be detached by a user, and a reflector device that can be swivelled relative to the imaging device. The reflector device is arranged in such a way that the image generated by the imaging device is visible via the reflector device to a vehicle occupant, in particular one who is located or seated in front of the reflector device. The display unit and the imaging device—apart from the swivelling reflector device—are arranged substantially parallel to the inside of the vehicle roof. When the reflector device is not in use, it is also arranged substantially parallel to the inside of the vehicle roof.

### BACKGROUND AND SUMMARY

The invention relates to a motor vehicle, in particular a passenger car, having a display unit which is arranged on an inner side of the vehicle roof.

DE 10 2016 225 745 A1 discloses a monitor for a vehicle interior, which is positioned on an inner side of the vehicle roof and can be folded between an in-use position and a roof position. For example, the monitor is arranged for the occupants of a second row of seats—behind a first row of seats having a driver's seat and a passenger's seat. If the monitor is to be sufficiently large, then the largest possible distance between the monitor and an occupant seated in front thereof is also required, so that the occupant can conveniently view content displayed on the monitor. For the greatest possible distance, the monitor has to be positioned as close as possible to the front seats. Such a monitor has a high weight, so that the mounting thereof must be dimensioned appropriately. The weight of the monitor also plays a role with regard to crash requirements.

The object of the present invention is to devise a motor vehicle having a display unit which is arranged on an inner side of the vehicle roof, wherein a distance of a user or occupant seated in front of the display unit to a display image is increased and the construction of the display unit is simplified.

This object is achieved by a display unit which has the combination of the features of the independent claim(s). Advantageous developments are recited in the dependent claims.

According to the invention, a motor vehicle has a display unit which is arranged on an inner side of the vehicle roof. The display unit has a permanently integrated imaging device, which in particular cannot be detached by a user, and a reflector device that can be swiveled relative to the imaging device. The reflector device is arranged in such a way that the image generated by the imaging device becomes visible via the reflector device to a vehicle occupant, in particular one who is located or seated in front of the reflector device. The display unit and the imaging device—apart from the swiveling reflector arrangement—are arranged substantially parallel to the inner side of the vehicle roof. When the reflector device is not in use, it is likewise arranged substantially parallel to the inner side of the vehicle roof.

The imaging device is a display, monitor, or the like, for example based on LCD, LED or OLED technology and variants thereof.

As a result, it is not necessary that the monitor itself, with its electrical connections and the electronics integrated therein, be arranged so as to be swivelable. In this way, the part of the display unit that can be swiveled can be designed to be lighter and, therefore, a kinematic system for swiveling the part of the display unit that can be swiveled can also be designed for a lower weight. The lower weight of the reflector device, as compared with a monitor, also has advantages in the event of a frontal collision, in which there is the possibility that an individual sitting in front of the reflector device will strike the reflector device, since the reflector device has a lower mass.

The motor vehicle is preferably a passenger car having a passenger compartment and advantageously has at least one first row of seats and a second row of seats, possibly also further rows of seats. The display unit is preferably designed for a second and/or third row of seats.

Preferably, the reflector device is formed from an inherently stiff panel, which in particular can be made from plastic, for example from plexiglass, a fiber-reinforced plastic or glass.

The reflector device should be sufficiently stiff with regard to a reflecting image, in order to avoid distortion of a reflecting image. For this purpose, a reinforcing frame can be provided. However, it is better to provide a reflector device comprising an inherently stiff panel—an inherently stiff panel is intrinsically rigid—and is sufficiently stiff without any additional supporting structure which needs no reinforcing frame or the like, this simplifying the structure of the reflector device and also improving and streamlining the appearance of the reflector device.

According to a preferred development, the reflector device has a reflective layer which, in particular, is polarized so as to correspond to light emerging from the imaging unit. In other words, the reflective layer of the reflector device can be matched to the characteristics of the imaging unit, for example the light emerging from the imaging unit can be p-polarized or polarized by an additionally applied polarizer. The reflector device can then advantageously be provided with a p-reflective layer, so that in particular the polarized light from the imaging unit is reflected but not other interior parts of the motor vehicle or other objects. Therefore, only the light from the imaging unit is reflected on the reflector device.

According to a preferred development, the reflector device can be transparent or partially transparent.

Transparency of the reflector device permits a view to the front for the user sitting in front of the same. In addition, a view toward the rear from another side of the reflector unit is made easier as a result of the fact that, for example if the display unit is arranged in a second row of seats, a driver of the motor vehicle in the first row of seats can have an improved view to the rear via an internal rear view mirror. In addition, a transparent or partially transparent reflector device is visually less restrictive for a vehicle interior and has a pleasing appearance.

Advantageously, the level of transparency of the reflector device is designed to be variable electrically or electronically. To this end, the reflector device can have a correspondingly controllable or switchable layer analogous to an intelligent or switchable glass. The switchable layer can be designed, for example, on the basis of the liquid-crystal (LC), polymer dispersed liquid-crystal (PDLC) or suspended-particle device (SPD) technologies.

According to a further preferred development, an external shape of the reflector device is matched to a reflector image. In particular, the reflector device is not square or rectangular.

The reflector image or reflected image results from a position of the imaging device and the reflector device relative to each other and a position of the eye of a user. A surface of the reflector device is, for example, arranged at an angle of 45°+/−10°, preferably +/−5°, with respect to a surface of the imaging device. This in turn means that, from the perspective of a user, a rectangular image emitted by the imaging device would not completely fill a likewise rectangular reflector device. Therefore, a width of the reflector device can be designed to be progressively smaller with increasing distance from a swivel axis of the reflector device, without this cutting off part of the image from the imaging device. Advantageously—because of the rectangular shape of the image from the imaging device—the reflector device is trapezoidal, wherein a short side of the trapezium is arranged remote from the swivel axis.

By adapting the outer shape of the reflector device to the reflected image, a weight of the reflector device can therefore be reduced. Therefore, the reflector device also restricts less space in the vehicle interior.

Preferably, the display unit—together with the imaging unit and the reflector device—is rotatable about an axis perpendicular to a display surface of the imaging device or about a vehicle vertical axis—a z-axis in the vehicle coordinate system. Alternatively, although the display unit is not designed to be rotatable about the y-axis, it is fixed so as to be rotated by a specific angle with respect to a vehicle transverse axis (y-axis) in a plane parallel to the vehicle longitudinal direction (x-axis) and vehicle transverse axis (y-axis).

Therefore, the position of the reflected image can be adapted suitably for the user seated in front of the same and, at the same time, it can be rotated away from a field of view of an individual seated beside the user, so this other individual cannot see the reflected image or at least see it less well.

Rotation of the display unit can be made possible, for example, in an angular range from −10° to +10° or the display unit can be mounted fixedly so as to be rotated about the vehicle vertical axis by an angle from the angular range from −10 to +10° from a vehicle transverse axis.

It can further be possible, for example, for the imaging device to be swivelable about a vehicle transverse axis—a y-axis in the vehicle coordinate system—for example by −10° to +10°. As a result, the display unit can be adapted better to a seated height of the user sitting in front of the display unit.

The imaging device can be swiveled about the y-axis manually or electrically. In particular, it can be swiveled about the y-axis automatically on the basis of a position of the eye of the user seated in front of the same, detected by appropriate sensors.

Furthermore, a screen can be arranged in the region of a rear edge of the imaging device.

The screen restricts the immediate sight of the user seated in front of the same of an image from the imaging device or prevents this sight completely. By means of the screen, the user seated in front of the same is not diverted by the image from the imaging device but only has the reflected image from the reflector device in the field of view.

The screen can be designed to be adjustable, so that it can, for example, be adjusted to different head or eye positions of the user seated in front of the screen.

Alternatively or additionally to the (mechanical) screen, the imaging device can be provided with a privacy filter or a privacy layer, which blocks or prevents a view outside a specific viewing angle, so that the user sitting in front of the screen cannot directly see the image from the imaging device but only the reflected image.

Preferably, an image from the imaging device can be scalable, in particular automatically or manually.

Thus, the size of an image is optimally adjustable, depending on the position of the reflector device, an eye position of the user seated in front of the same and the position of the imaging device.

The image from the imaging device can be scalable automatically on the basis of an eye position which, for example, can be detected by a camera, of a user seated in front of the same and/or the position of the reflector device and/or the position of the imaging device.

According to a preferred development, the reflector device can be swiveled between an out-of-use position, in which the reflector device is, for example, located substantially parallel to the imaging device, and in-use positions.

Therefore, when it is not being used, the reflector device can be swiveled in such a way that it no longer restricts the vehicle internal space and, for example, is not obstructive when entering and/or leaving the motor vehicle.

The reflector device could be swivelable automatically into the out-of-use position and into the in-use position as required. The reflector device can be swivelable automatically into the in-use position on the basis of an eye position of a user.

The display unit can have an electric drive for swiveling the reflector device.

The reflector device and the imaging device can be continuous over at least half of the width, preferably at least two thirds of the width, in particular substantially the whole of the width of the inner side of the vehicle roof.

The reflector device can be mounted such that it can be swiveled about a real or virtual, stationary or locally variable axis which extends in a vehicle transverse direction.

The imaging device can have an aspect ratio of 4 to 3 or 16 to 9 or 21 to 9 or 32 to 9, wherein the reflector device can have a corresponding size—optionally appropriately trapezoidal.

The display unit can be mounted such that it can be displaced in the vehicle longitudinal direction (x-axis). In particular, it can have an electric drive for the displacement in the vehicle longitudinal direction.

The display unit can be fixed and mounted on a left-hand roof side frame and on a right-hand roof side frame.

The aforementioned features can be combined with one another as desired to the extent that this is possible and expedient.

There follows a brief description of the figures.

### BRIEF DESCRIPTION OF THE DRAWINGS

FIG. 1 is a schematic side view of a display unit of a motor vehicle according to an exemplary embodiment of the present invention in an out-of-use position;

FIG. 2 is a schematic side view of the display unit of the motor vehicle according to the exemplary embodiment of the present invention in an in-use position; and

FIG. 3 is a schematic plan view from below or above of the display unit of the motor vehicle according to the exemplary embodiment of the present invention.

### DETAILED DESCRIPTION OF THE DRAWINGS

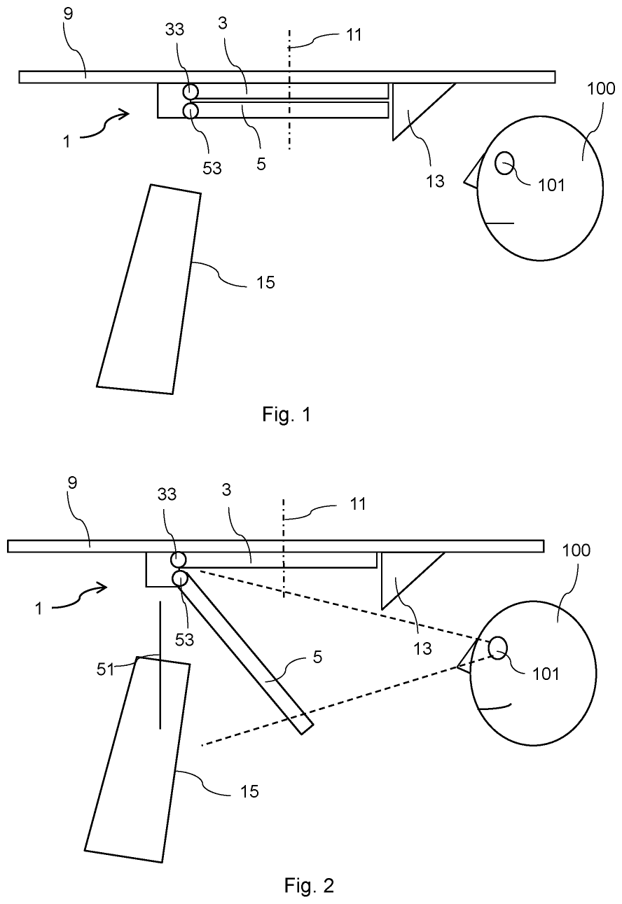

An exemplary embodiment of the present invention is explained below with reference to FIGS. 1 to 3.

As shown in FIG. 1, a motor vehicle according to the exemplary embodiment has a display unit 1 which is permanently integrated into a roof lining or a vehicle roof 9 so that it cannot be detached by a user and which, for example, is arranged in the area of a rear, in particular second, row of seats for the occupants of the rear row of seats. The display unit 1 can be arranged specifically for a specific seat but it can also be arranged in such a way that it is visible from a plurality of seats of the row of seats.

The display unit 1 has a display 3, which means an imaging device, which is arranged parallel to a side of the roof lining or the vehicle roof 9 facing the vehicle interior. In addition, the display unit 1 has a reflector device 5, which can be swiveled relative to the display 3 about an axis 53. The axis 53 extends substantially parallel to a vehicle transverse axis, i.e. a y-axis in the vehicle coordinate system, and is formed in the area of a front section of the display unit 1. As explained below, the axis 53 can also extend somewhat obliquely relative to the vehicle transverse axis. An occupant 100 who sits behind the display unit 1 in the direction of travel is illustrated schematically with a head and eyes 101. Part of the display unit 1 is also a screen 13 which, in the direction of travel, is arranged behind the display 3 and, for the occupants 100, restricts or even completely prevents immediate sight of the display. The function of the screen 13 of course depends on the position of the eyes 101 of the occupant 100 relative to the display. In this exemplary embodiment, the panel 13 is immovable. Alternatively, the screen 31 could also be designed to be adjustable, so that it can be adjusted manually or automatically relative to the eye position.

The reflector device 5 comprises an inherently stiff panel without further supporting structure, which is made of transparent plexiglass. Furthermore, the reflector device has a reflective layer, which reflects the image of the display.

The reflector device 5 can also be designed to be non-transparent or the level of transparency of the reflector device is designed to be variable electrically or electronically, analogous to an intelligent, switchable glass pane, by means of LC, PDLC or SPD technology.

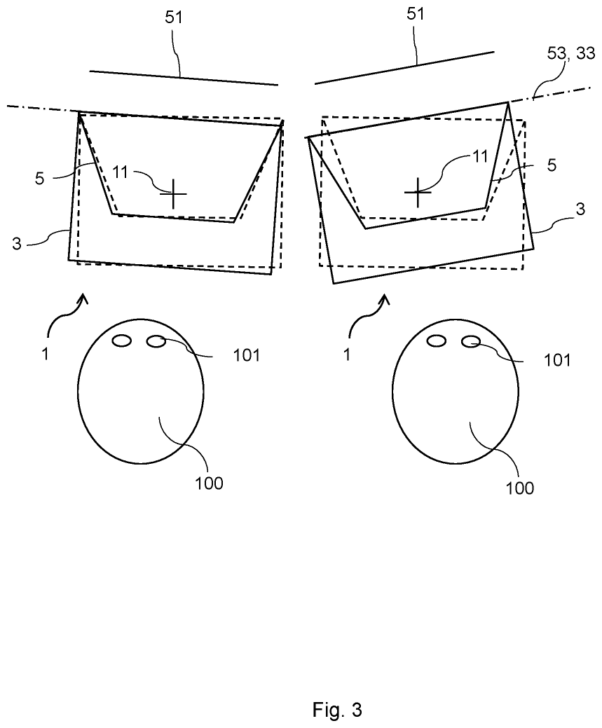

In the side view of FIG. 1, the reflector device 5 is in an out-of-use position and is arranged parallel to the display 3. In the side view of FIG. 2, the reflector device 5 has been swiveled downward about the axis 53 by an angle of approximately 45°.

When the display 3 is switched on, an image of the display surface of the display 3 is reflected on the reflector device 5. This produces a reflector image 51 which, from the perspective of the occupant 100 behind the reflector device 5, appears to float in space, even if there is a front seat 15 or a head support of the front seat 15 located there.

The display unit 1 can additionally be rotatable as a whole by a few degrees, for example in an angular range from −10° to +10° about a vertical axis 11 (a z-axis in the vehicle coordinate system). In this way, the display unit 1 can be adapted for the occupant 101, for example if the latter sits somewhat obliquely.

As is shown in FIG. 3, two display units 1 can be arranged beside each other, so that the respective occupants on two seats beside each other can use a display unit 1 independently of each other. In this case, it is particularly expedient if the display units 1 are rotatable about their vertical axes 11 or are mounted at least somewhat rotated relative to each other. As shown in FIG. 3, the left-hand display unit 1 is rotated to the left by a few degrees, and the right-hand display unit 1 is rotated to the right by a few degrees. In this way, the respective reflector images are less well visible to a seated neighbor. A position of the display units 1 in which they are located parallel to the vehicle transverse axis is illustrated by means of dashed lines.

As can be seen in particular in FIG. 3, the reflector device 5 has a trapezoidal shape. A rear edge, i.e. a lower edge in the in-use state, of the reflector device 5 is shorter than a front edge (close to the swivel axis 53) of the reflector device 5. The trapezoidal shape is matched to the angular position of the reflector device 5 in the in-use position shown in FIG. 2 and therefore to the reflector image 51. The trapezoidal shape is configured in such a way that the reflector image 51 still just shows the image of the imaging device 3 completely. The trapezoidal shape has the advantage that, without any functional restriction with regard to the reflector image 51, the reflector device 5 restricts an internal space less both optically and also in practice, as compared with a rectangular reflector device. Moreover, the reflector device 5 is also lighter as a result.

As is shown in FIG. 1, it can likewise be possible for the imaging device 3 to be swivelable about a vehicle transverse axis 33, i.e. an axis parallel to the y-axis in the vehicle coordinate system, in a limited angular range, i.e. by a few degrees, for example −10° to +10°. This permits an additional possibility of adjustment with regard to an eye position of the occupant 100.

The rotation of the reflector device 5 about the axis 53 and the rotation of the display about the axis 33 and also the rotation of the entire display unit 1 about the axis 11 can be automated by means of an electric actuating drive on the basis of a sensor-detected eye position of the user 100. Alternatively, all these adjustments can be carried out manually by the user 100.

1.-9. (canceled)

10. A motor vehicle having a display unit, comprising:
a permanently integrated imaging device; and
a reflector device that is swivelable relative to the imaging device and is arranged such that an image generated by the imaging device becomes visible, via the reflector device, to a vehicle occupant seated in front of the reflector device,
wherein the display unit is arranged on an inner side of the vehicle roof, and
wherein the imaging device is arranged substantially parallel to the inner side of the vehicle roof.

11. The motor vehicle according to claim 10, wherein
the reflector device is an inherently stiff panel.

12. The motor vehicle according to claim 11, wherein
the inherently stiff panel is made from a plastic, a plexiglass, a fiber-reinforced plastic, or glass, and
the reflector device has a reflective layer.

13. The motor vehicle according to claim 10, wherein
the reflector device is transparent or partially transparent, and
a level of transparency of the reflector device is variable.

14. The motor vehicle according to claim 10, wherein
an external shape of the reflector device is matched to a reflector image.

15. The motor vehicle according to claim 14, wherein
a width of the reflector device is progressively smaller with increasing distance from a swivel axis of the reflector device, and wherein the reflector device is preferably trapezoidal.

16. The motor vehicle according to claim 10, wherein
the reflector device has a trapezoidal shape.

17. The motor vehicle according to claim 10, wherein the display unit is rotatable about:
an axis perpendicular to a display surface of the imaging device, or
a vehicle vertical axis.

18. The motor vehicle according to claim 10, wherein
the imaging device is swivelable about a swivel axis parallel to a vehicle transverse axis.

19. The motor vehicle according to claim 18, wherein
the imaging device is swivelable about the swivel axis in a range of −10° to +10°.

20. The motor vehicle according to claim 10, further comprising:
a screen formed in a region of a rear edge of the imaging device,
wherein the screen is configured to be adjustable.

21. The motor vehicle according to claim 10, wherein
an image from the imaging device is scalable, automatically or manually.

22. The motor vehicle according to claim 21, wherein
the image from the imaging device is scaled automatically based on an eye position of the vehicle occupant.

23. The motor vehicle according to claim 10, wherein
the reflector device is swivelable between an out-of-use position and an in-use position.
